(19) United States
(12) Patent Application Publication
(10) Pub. No.: US 2024/0126483 A1
(43) Pub. Date: Apr. 18, 2024

(54) AUTOMATIC OS ROLLBACK

(71) Applicant: Dell Products L.P., Round Rock, TX (US)

(72) Inventors: Qian YANG, Shanghai (CN); Lixia HU, Shanghai (CN); Zhuo ZHANG, Shanghai (CN); Zhang FLAG, Shanghai (CN)

(73) Assignee: Dell Products L.P., Round Rock, TX (US)

(21) Appl. No.: 17/980,329

(22) Filed: Nov. 3, 2022

(30) Foreign Application Priority Data
Oct. 14, 2022 (CN) 202211264207.0

(51) Int. Cl. G06F 3/06

(52) U.S. Cl. CPC G06F 3/0665; G06F 3/0614; G06F 3/0689

(57) ABSTRACT

An information handling system may include a mirrored plurality of physical storage resources configured to operate as a single virtual storage resource. The information handling system may be configured to: prior to performing a sensitive operation, cause the virtual storage resource to enter a degraded state by taking a selected physical storage resource of the plurality of physical storage resources offline; perform the sensitive operation, wherein performing the sensitive operation includes writing data to a remaining physical storage resource of the plurality of physical storage resources; and in response to a failure of the sensitive operation, cause data to be copied from the selected physical storage resource to the remaining physical storage resource.

### TECHNICAL FIELD

The present disclosure relates in general to information handling systems, and more particularly to techniques for rolling back changes that have been made to an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Updating an operating system (OS), performing lifecycle management, and performing other sensitive operations in information handling systems can entail some risk of malfunction. Such a malfunction can result in a system that no longer boots, and remediation can take significant time and resources.

Accordingly, it is beneficial to be able to roll back changes to a system if an update malfunctions. Existing methods tend to be complex and time-consuming, and they require significant storage space for storing the rollback information.

Embodiments of this disclosure improve on existing rollback functionality by using mirrored storage resources. For example, hardware or software RAID functionality (e.g., RAID 1, RAID 10, etc.) provides a virtual storage volume that operates like a single disk, but is backed by two or more mirrored physical storage resources. Embodiments of this disclosure may leverage such mirroring functionality to create an ephemeral snapshot before or during the update process. With this approach, OS updates, lifecycle management events, and other sensitive operations can be completed resiliently, and in the event of a failure, a system can be easily rolled back to a previous state.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with rolling back changes in information handling systems may be reduced or eliminated.

In accordance with embodiments of the present disclosure, an information handling system may include a mirrored plurality of physical storage resources configured to operate as a single virtual storage resource. The information handling system may be configured to: prior to performing a sensitive operation, cause the virtual storage resource to enter a degraded state by taking a selected physical storage resource of the plurality of physical storage resources offline; perform the sensitive operation, wherein performing the sensitive operation includes writing data to a remaining physical storage resource of the plurality of physical storage resources; and in response to a failure of the sensitive operation, cause data to be copied from the selected physical storage resource to the remaining physical storage resource.

In accordance with these and other embodiments of the present disclosure, a method may include an information handling system that includes a mirrored plurality of physical storage resources configured to operate as a single virtual storage resource causing the virtual storage resource to enter a degraded state by taking a selected physical storage resource of the plurality of physical storage resources offline; subsequent to taking the selected physical storage resource offline, the information handling system performing a sensitive operation, wherein performing the sensitive operation includes writing data to a remaining physical storage resource of the plurality of physical storage resources; and in response to a failure of the sensitive operation, the information handling system causing data to be copied from the selected physical storage resource to the remaining physical storage resource.

In accordance with these and other embodiments of the present disclosure, an article of manufacture may include a non-transitory, computer-readable medium having computer-executable code thereon that is executable by a processor of an information handling system that includes a mirrored plurality of physical storage resources configured to operate as a single virtual storage resource, the code being executable for: prior to performing a sensitive operation, causing the virtual storage resource to enter a degraded state by taking a selected physical storage resource of the plurality of physical storage resources offline; performing the sensitive operation, wherein performing the sensitive operation includes writing data to a remaining physical storage resource of the plurality of physical storage resources; and in response to a failure of the sensitive operation, causing data to be copied from the selected physical storage resource to the remaining physical storage resource.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIGS. 2A and 2B illustrate an example data storage system, in accordance with embodiments of the present disclosure.

### DETAILED DESCRIPTION

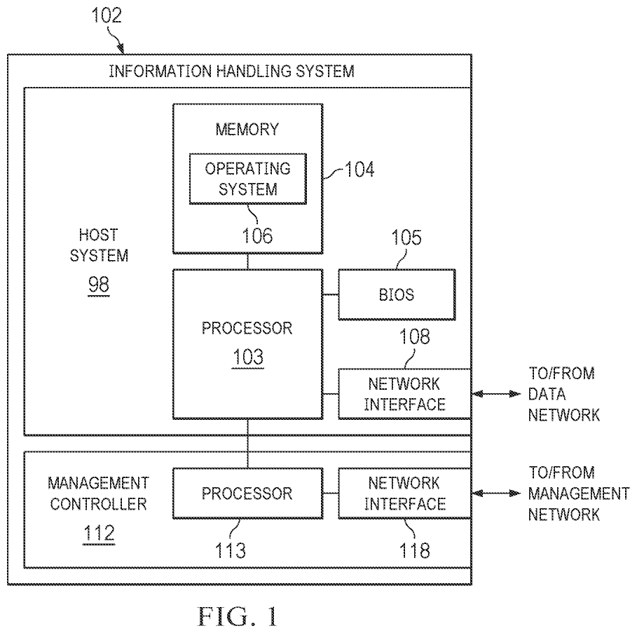

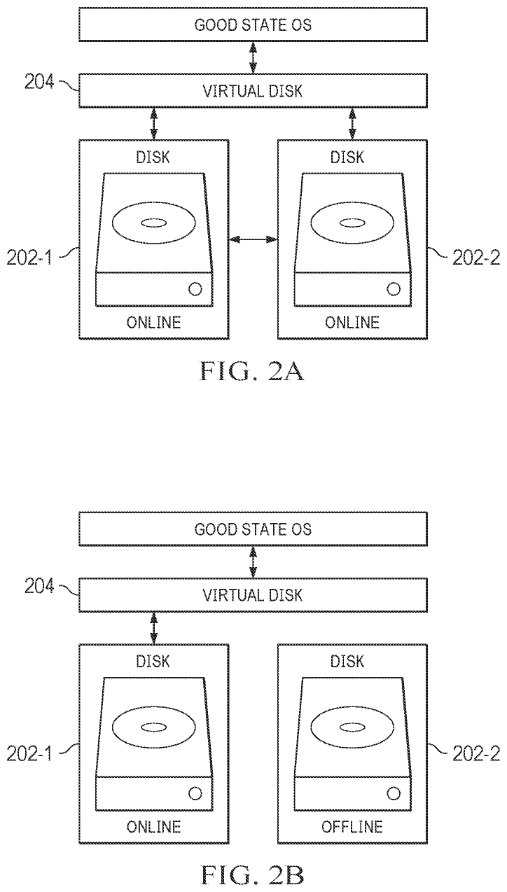

Preferred embodiments and their advantages are best understood by reference to FIGS. 1 through 2B, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives, solid-state drives, and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

In some embodiments, memory 104 may include a plurality of physical storage resources (e.g., hard drives, solid-state drives, etc.) that are managed by a storage controller. The storage controller may be a component of a motherboard of information handling system 102, or it may be implemented as a separate component. For the sake of clarity and concreteness, the example of a RAID-1 volume backed by two physical storage resources is discussed in detail herein. One of ordinary skill in the art with the benefit of this disclosure will appreciate that other arrangements (e.g., a RAID-1 volume with more than two physical storage resources, a RAID-10 volume, etc.) are also possible in specific implementations.

When an update or other sensitive operation needs to take place, the mirrored volume may first be split into two portions (e.g., by taking one selected drive offline). The result is effectively the same as a RAID volume operating in a degraded state after a drive failure. This splitting may be accomplished by management controller 112 and/or some other component interfacing with a storage controller and/or a storage resource to cause the selected storage resource to be communicatively decoupled from the system. For example, the storage resource may be powered down in some instances. In other cases, the storage resource may remain powered, but its storage controller may treat it as offline.

FIGS. 2A and 2B illustrate an example of a RAID-1 virtual disk 204 that is backed by mirrored physical disks 202-1 and 202-2. Memory 104 may include a storage system such as the one shown in FIGS. 2A and 2B, in some embodiments. Operating system 106 may reside on virtual disk 204.

In FIG. 2A, the system is operating in a normal state, in which any data written to virtual disk 204 is reflected in both of physical disks 202-1 and 202-2. The OS is in a good and usable state.

In FIG. 2B, the RAID-1 virtual disk 204 has been split by taking physical disk 202-2 offline. Physical disk 202-2 retains all of the data that was written to virtual disk 204 prior to the time that the splitting occurred, effectively forming a snapshot of virtual disk 204 as of that moment. Any subsequent writes to virtual disk 204 are reflected only in physical disk 202-1. The system continues operating, and the OS is still in a good and usable state.

The arrangement of FIGS. 2A and 2B may be employed to implement an automatic rollback mechanism, which may be used for protection in situations such as OS upgrades and the like. For example, an update script such as a lifecycle management script may be executed to apply a new OS image. The script may execute on host system 98 and/or management controller 112. The script may include instructions configured to place physical disk 202-2 in an offline state, then apply the update, then reboot host system 98.

If the update is applied successfully and host system 98 boots into the new OS, the update script may place physical disk 202-2 in an online state, and the storage controller may automatically begin the process of mirroring the changes (e.g., the new OS image) from physical disk 202-1 to physical disk 202-2.

If, on the other hand, the update fails for some reason, then the failure may be detected by management controller 112 or some other component. For example, if host system 98 fails to boot the new OS image (e.g., it hangs or encounters some error condition), then management controller 112 may cause the storage controller to roll back the changes by copying the data from physical disk 202-2 (the mirrored snapshot) onto physical disk 202-1. Virtual disk 204 may then be brought back online in its previous state, and the previous OS may boot normally.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a mirrored plurality of physical storage resources configured to operate as a single virtual storage resource;
wherein the information handling system is configured to:
prior to performing a sensitive operation, cause the virtual storage resource to enter a degraded state by taking a selected physical storage resource of the plurality of physical storage resources offline;
perform the sensitive operation, wherein performing the sensitive operation includes writing data to a remaining physical storage resource of the plurality of physical storage resources; and
in response to a failure of the sensitive operation, cause data to be copied from the selected physical storage resource to the remaining physical storage resource.

2. The information handling system of claim 1, wherein the sensitive operation is an upgrade of an operating system of the information handling system.

3. The information handling system of claim 1, wherein the sensitive operation is a lifecycle management operation.

4. The information handling system of claim 1, wherein the virtual storage resource is a RAID-1 storage resource.

5. The information handling system of claim 1, wherein the information handling system further includes a management controller configured to provide out-of-band management of the information handling system, and wherein the management controller is configured to take the selected physical storage resource offline.

6. The information handling system of claim 5, wherein the management controller is further configured to detect the failure by determining that a reboot of the information handling system has failed.

7. A method comprising:
an information handling system that includes a mirrored plurality of physical storage resources configured to operate as a single virtual storage resource causing the virtual storage resource to enter a degraded state by taking a selected physical storage resource of the plurality of physical storage resources offline;
subsequent to taking the selected physical storage resource offline, the information handling system performing a sensitive operation, wherein performing the sensitive operation includes writing data to a remaining physical storage resource of the plurality of physical storage resources; and
in response to a failure of the sensitive operation, the information handling system causing data to be copied from the selected physical storage resource to the remaining physical storage resource.

8. The method of claim 7, wherein the sensitive operation is an upgrade of an operating system of the information handling system.

9. The method of claim 7, wherein the sensitive operation is a lifecycle management operation.

10. The method of claim 7, wherein the virtual storage resource is a RAID-1 storage resource.

11. The method of claim 7, wherein the information handling system further includes a management controller configured to provide out-of-band management of the information handling system, and wherein the management controller takes the selected physical storage resource offline.

12. The method of claim 11, wherein the management controller detects the failure by determining that a reboot of the information handling system has failed.

13. An article of manufacture comprising a non-transitory, computer-readable medium having computer-executable code thereon that is executable by a processor of an information handling system that includes a mirrored plurality of physical storage resources configured to operate as a single virtual storage resource, the code being executable for:
prior to performing a sensitive operation, causing the virtual storage resource to enter a degraded state by taking a selected physical storage resource of the plurality of physical storage resources offline;
performing the sensitive operation, wherein performing the sensitive operation includes writing data to a remaining physical storage resource of the plurality of physical storage resources; and
in response to a failure of the sensitive operation, causing data to be copied from the selected physical storage resource to the remaining physical storage resource.

14. The article of claim 13, wherein the sensitive operation is an upgrade of an operating system of the information handling system.

15. The article of claim 13, wherein the sensitive operation is a lifecycle management operation.

16. The article of claim 13, wherein the virtual storage resource is a RAID-1 storage resource.

17. The article of claim 13, wherein the information handling system further includes a management controller configured to provide out-of-band management of the information handling system, and wherein the management controller is configured to take the selected physical storage resource offline.

18. The article of claim 17, wherein the management controller is further configured to detect the failure by determining that a reboot of the information handling system has failed.
